(19) United States
(12) Patent Application Publication
(10) Pub. No.: US 2016/0112070 A1
(43) Pub. Date: Apr. 21, 2016

(54) ANTENNA MODULE AND CONTROL METHOD THEREOF

(71) Applicant: SAMSUNG ELECTRO-MECHANICS CO., LTD., Suwon-Si (KR)

(72) Inventor: Seung Hun RYU, Suwon-Si (KR)

(21) Appl. No.: 14/721,815

(22) Filed: May 26, 2015

(30) Foreign Application Priority Data
Oct. 16, 2014 (KR) 10-2014-0139987

(51) Int. Cl. H04B 1/00; H01Q 21/30; H04B 17/318; H01Q 1/48

(52) U.S. Cl. CPC H04B 1/006; H01Q 1/48; H01Q 21/30; H04B 17/318

(57) ABSTRACT

An antenna module may include a printed circuit board including a main ground unit disposed on one surface thereof, a first ground array unit connected to the main ground unit through a first switching unit, and a second ground array unit connected to the main ground unit through a second switching unit, and an antenna pattern unit connected to the printed circuit board and transmitting and receiving at least one frequency band signal, wherein the printed circuit board further includes a switching controlling unit controlling switching operations of the first and second switching units according to RSSI of the signal provided to the antenna pattern unit, and the first ground array unit is disposed on one surface of the printed circuit board and the second ground array unit is disposed on the other surface opposing one surface of the printed circuit board.

### CROSS-REFERENCE TO RELATED APPLICATION

This application claims priority to, and the benefit of Korean Patent Application No. 10-2014-0139987 filed on Oct. 16, 2014, with the Korean Intellectual Property Office, the disclosure of which is incorporated herein by reference.

### BACKGROUND

This application relates to an antenna module and a control method thereof.

As a communications technology has moved from 2G and 3G to 4G, existing smartphones need to be able to operate within multiple bands, within a wider range than just the 2G and 3G frequency bands.

Examples of methods for implementing antennas able to operate in multiple 2G, 3G, and 4G bands, currently provided in smartphones, include a method of adjusting a length of an antenna pattern using a switching element and a method of shifting a resonance frequency by applying a variable capacitor to a load of the antenna pattern.

However, the two methods as mentioned above are not considered with relation to gain and efficiency, radiation characteristics of antennas, except for the implementation of a multiple band resonance frequency of the antenna.

Particularly, in an antenna pattern according to the related art, since a current may be concentrated on an electricity feeding point portion to which a printed circuit board is electrically connected, it may be difficult to secure sufficient degrees of gain and the efficiency therein.

### SUMMARY

An exemplary embodiment in the present disclosure may provide an antenna module capable of increasing gain and efficiency, radiation characteristics of antennas, by adjusting a ground of an antenna pattern depending on received signal strength indicator (RSSI) of a signal provided from the antenna, and a control method thereof.

According to an exemplary embodiment in the present disclosure, an antenna module may include: a printed circuit board including a main ground unit disposed on one surface thereof, a first ground array unit connected to the main ground unit through a first switching unit, and a second ground array unit connected to the main ground unit through a second switching unit; and an antenna pattern unit connected to the printed circuit board and transmitting and receiving at least one frequency band signal, wherein the printed circuit board further includes a switching controlling unit controlling switching operations of the first and second switching units according to RSSI of the signal provided to the antenna pattern unit, and the first ground array unit is disposed on one surface of the printed circuit board and the second ground array unit is disposed on the other surface opposing one surface of the printed circuit board.

According to another exemplary embodiment in the present disclosure, a control method of an antenna module may include: measuring RSSI of a signal provided to an antenna pattern unit; comparing the measured RSSI of the signal and RSSI of a reference signal; and controlling switching operations of a first switching unit opening or closing a signal path between a main ground unit and a first ground array unit of a printed circuit board to be electrically conducted or blocked and a second switching unit opening or closing a signal path between the main ground unit and a second ground array unit of the printed circuit board to be electrically conducted or blocked, depending on the comparison result, wherein the first ground array unit is disposed on one surface of the printed circuit board and the second ground array unit is disposed on the other surface opposing one surface of the printed circuit board.

### BRIEF DESCRIPTION OF DRAWINGS

The above and other aspects, features and other advantages in the present disclosure will be more clearly understood from the following detailed description taken in conjunction with the accompanying drawings, in which:

FIG. 1 is a block diagram illustrating an antenna module according to an exemplary embodiment in the present disclosure;

FIG. 2 is a diagram illustrating a connection relationship between components of the antenna module according to an exemplary embodiment in the present disclosure;

FIG. 3 is a diagram illustrating a rear surface of a printed circuit board the antenna module illustrated in FIG. 2; and

FIG. 4 is a flow chart illustrating a control method of an antenna module according to an exemplary embodiment in the present disclosure.

### DETAILED DESCRIPTION

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope in the disclosure to those skilled in the art.

In the drawings, the shapes and dimensions of elements maybe exaggerated for clarity, and the same reference numerals will be used throughout to designate the same or like elements.

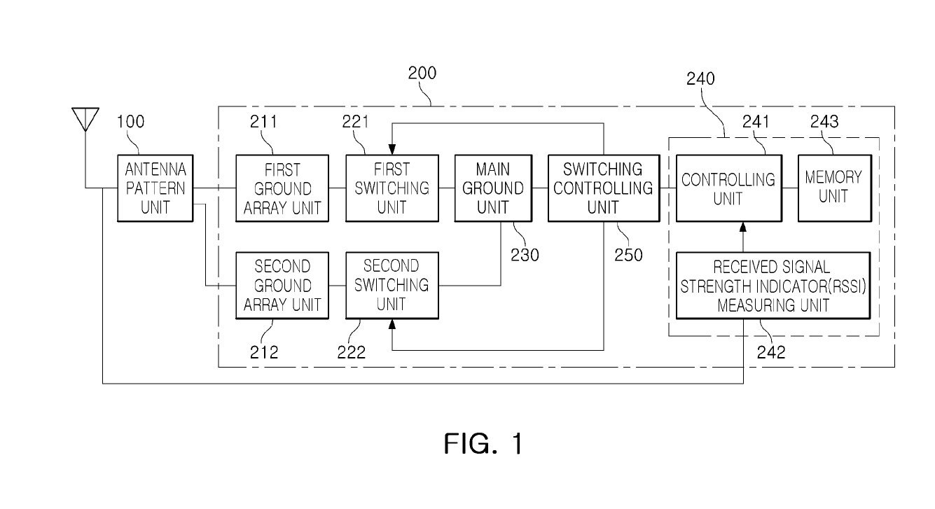

FIG. 1 is a block diagram illustrating an antenna module according to an exemplary embodiment in the present disclosure.

Referring to FIG. 1, an antenna module according to an exemplary embodiment in the present disclosure may include an antenna pattern unit 100 and a printed circuit board 200.

The antenna pattern unit 100 may be electrically connected to the printed circuit board 200 to transmit and receive at least one frequency band signal.

The printed circuit board 200 may include a main ground unit 230, a first ground array unit 211, and a second ground array unit 212. The main ground unit 230 and the first ground array unit 211 may be connected to each other through a first switching unit 221, and the main ground unit 230 and the second ground array unit 212 may be connected to each other through a second switching unit 222.

More specifically, the main ground unit 230 and the first ground array unit 211 may be disposed on one surface of the printed circuit board 200, and the second ground array unit 212 may be disposed on the other surface opposing one surface of the printed circuit board 200. Further, the first ground array unit 211 may be disposed to face the antenna pattern unit 100.

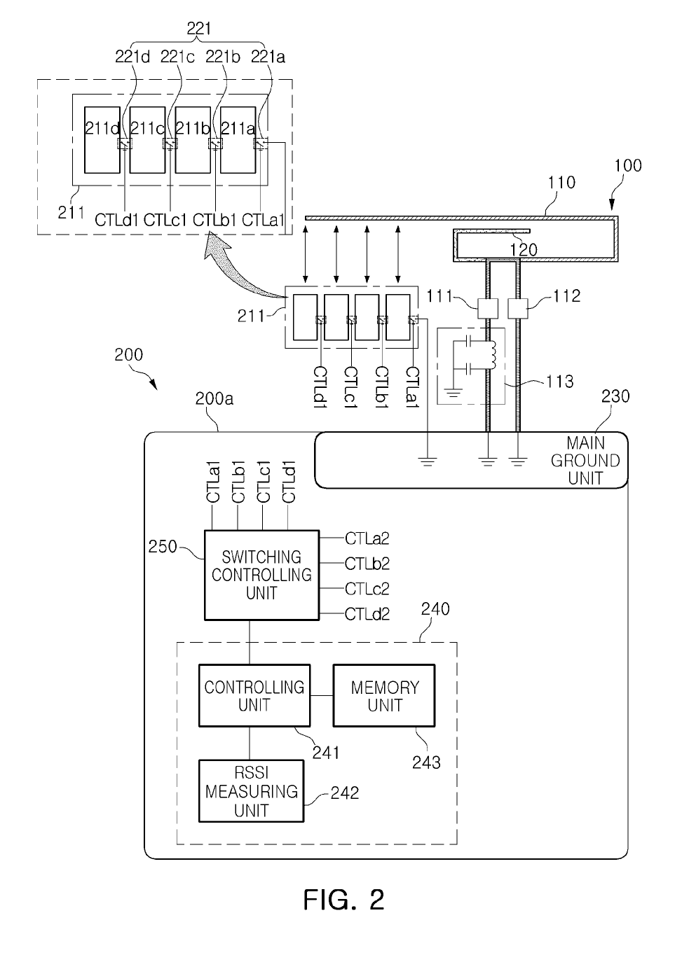

The first ground array unit 211 may include a plurality of first ground units 211a to 211d (see FIG. 2) which are connected to each other through a plurality of first switching elements 221a to 221d (see FIG. 2).

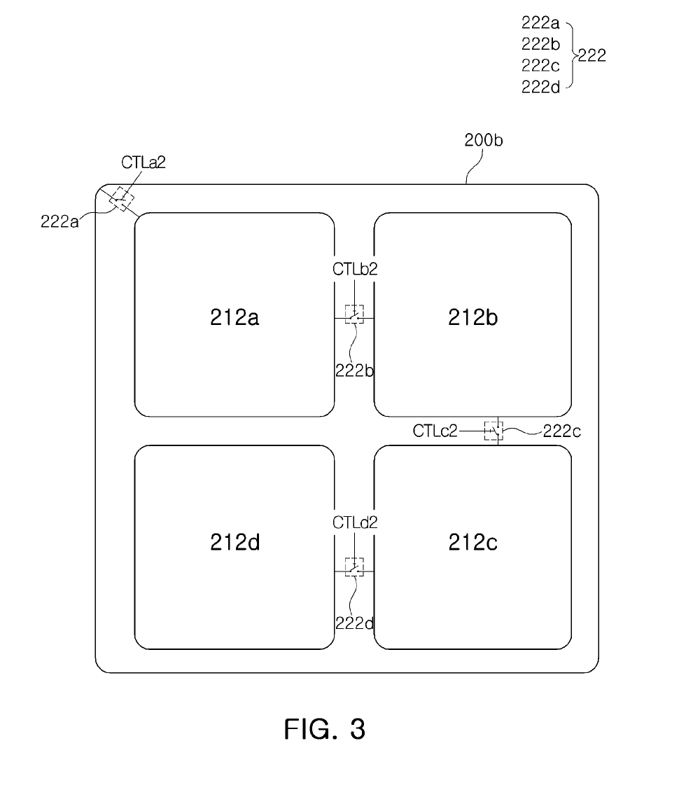

In addition, the second ground array unit 212 may include a plurality of second ground units 212a to 212d (see FIG. 3) which are connected to each other through a plurality of second switching elements 222a to 222d (see FIG. 3).

Meanwhile, the printed circuit board 200 may further include a switching controlling unit 250 controlling switching operations of the first and second switching units 221 and 222 depending on received signal strength indicator (RSSI) of a signal provided to the antenna pattern unit 100.

In this case, the first switching unit 221 may include a first main switching element 221a (see FIG. 2) opening or closing a signal path between the first ground array unit 211 and the main ground unit 230 to be electrically conducted or blocked, and the plurality of first switching elements 221b to 221d (see FIG. 2).

In addition, the second switching unit 222 may include a second main switching element 222a (see FIG. 2) opening or closing a signal path between the second ground array unit 212 and the main ground unit 230 to be electrically conducted or blocked, and the plurality of second switching elements 222b to 222d (see FIG. 2).

In addition, the printed circuit board 200 may further include an MCU 240 having a controlling unit 241, a RSSI measuring unit 242, and a memory unit 243.

The memory unit 243 may be configured of a memory, or the like, and may store data generated during operating of a program, or the like. In addition, the memory unit 243 may store RSSI of a preset reference signal.

The RSSI measuring unit 242 may measure RSSI of the signal provided to the antenna pattern unit 100 and may provide the measured RSSI of the signal to the controlling unit 241. In this case, the RSSI of the signal may be RSSI of a signal obtained by coupling an external signal received by the antenna pattern unit 100, or may also be RSSI of a signal obtained by coupling a transmit signal reflected by the antenna pattern unit 100.

The controlling unit 241 may control a general function of the respective components. Particularly, the controlling unit 241 may compare RSSI of the signal provided from the RSSI measuring unit 242 and RSSI of the reference signal stored in the memory unit 243, and may generate a control signal corresponding to the comparison result to be provided to the switching controlling unit 250.

Although not illustrated in the drawings, the antenna module according to an exemplary embodiment in the present disclosure may further include a wireless communications unit disposed on the printed circuit board 200. The wireless communications unit may transmit and receive a plurality of frequency band signals, and more particularly, may provide the plurality of frequency band signals output from the controlling unit 241 to the antenna pattern unit 100 or provide the plurality of frequency band signals provided by the antenna pattern unit 100 to the controlling unit 241.

In addition, the wireless communications unit may couple the transmit signal reflected by the antenna pattern unit 100 to be provided to the RSSI measuring unit 242, or may also couple the received signal provided by the antenna pattern unit 100 to be provided to the RSSI measuring unit 242.

The switching controlling unit 250 may control switching operations of the first and second switching units 221 and 222, depending on the control signal provided from the controlling unit 241.

A description thereof will be provided with reference to FIGS. 2 and 3.

FIG. 2 is a diagram illustrating a connection relationship between components of the antenna module according to an exemplary embodiment in the present disclosure.

FIG. 3 is a diagram illustrating a rear surface of a printed circuit board 200 of the components of the antenna module illustrated in FIG. 2.

Referring to FIGS. 1 through 3, a feed point 111 which is electrically connected to the antenna pattern unit 100 may be disposed on one surface 200a of the printed circuit board 200. The antenna pattern unit 100 may also be electrically connected to a ground point 112 disposed in a position spaced apart from the feed point 111 by a predetermined distance.

The antenna pattern unit 100 may be provided with at least one frequency band signal through a stub 113 which is electrically connected to the feed point 111 and may apply the at least one frequency band signal to the printed circuit board 200.

More specifically, the antenna pattern unit 100 may be configured of a first radiator 110 transmitting and receiving a first frequency band signal and a second radiator 120 transmitting and receiving a second frequency band signal.

The first frequency band signal and the second frequency band signal may have different frequency bands, and also, lengths of the first and second radiators 110 and 120 may be set to be different from each other depending on the first and second frequency bands.

According to an exemplary embodiment, the first frequency band signal may have an LTE frequency band (5G), and the second frequency band signal may have 2G and 3G frequency bands. The first radiator 110 maybe used as a planar inverted-F antenna (PIFA), and the second radiator 120 may be used as a monopole type radiator having only an electricity feeding structure.

For example, the antenna pattern unit 100 may be operated to be tuned to a resonance frequency band of a radiating element of an antenna itself due to a change in output impedance, and may transmit and receive at least one frequency band signal according to the control signal of the controlling unit 241.

Referring to FIG. 2, the printed circuit board 200 may have the main ground unit 230 disposed on one surface (200a) thereof.

The main ground unit 230 and the first ground array unit 211 may be electrically connected to each other through the first main switching element 221a. More specifically, the first ground array unit 211 may include the plurality of first ground units 211a to 211d, and one 211a (see FIG. 2) of the plurality of first ground units 211a to 211d may be electrically connected to the main ground unit 230 through the first main switching element 221a. In addition, the rest 211b to 211d of the plurality of first ground units 211a to 211d may be electrically conducted to each other or blocked from each other through the plurality of first switching elements 221b to 221d.

Although the case in which the plurality of first ground units 211a to 211d include four first ground units is described in FIG. 2 by way of example, the present disclosure is not limited thereto. For example, the number of first ground units in the plurality of first ground units 211a to 211d may be changed depending on a length of the first radiator 110, and the number of first switching elements may also be changed depending on the number of first ground units.

Referring to FIG. 3, the second ground array unit 212 may be disposed on the other surface 200b opposing one surface 200a of the printed circuit board 200. For example, when one surface of the printed circuit board 200 is a front surface 200a, the second ground array unit 212 maybe disposed on a rear surface 200b of the printed circuit board 200.

In this case, the second ground array unit 212 may include the plurality of second ground units 212a to 212d. In addition, the second switching unit 222 may include the second main switching element 222a and the plurality of second switching elements 222b to 222d.

One second ground unit 212a of the plurality of second ground units 212a to 212d may be electrically connected to the main ground unit 230 disposed on one surface 200a of the printed circuit board 200 through the second main switching element 222a.

In addition, the remainder of the second ground units 212b to 212d of the plurality of second ground units 212a to 212d may be electrically conducted to each other or may be electrically blocked from each other through the second switching elements 222b to 222d.

Similarly, although the case in which the plurality of second ground units 212a to 212d include four second ground units is also described in FIG. 3 by way of example, the present disclosure is not limited thereto. Meanwhile, the number of second switching elements may also be changed depending on the number of second ground units in the plurality of second ground units.

Meanwhile, the switching elements included in the first and second switching units 221 and 222 may be an RF switching element, but are not limited thereto.

The switching controlling unit 250 may control switching operations of the first and second switching units 221 and 222 depending on the control signal of the controlling unit 241.

More specifically, when RSSI of the signal provided to the antenna pattern unit 100 is lower than RSSI of the reference signal stored in the memory unit 243, the controlling unit 241 may generate a control signal for improving RSSI to be provided to the switching controlling unit 250.

In this case, the switching controlling unit 250 may sequentially block the first switching element 222d most distant from the first main switching element 221a among the plurality of first switching elements 221b to 222d to the first main switching element 221a.

For example, the switching controlling unit 250 may sequentially remove the grounds of the first ground array unit 211 below the first radiator 110. Thereby, gain and efficiency of the antenna pattern unit 100 may be increased, thereby improving radiation characteristics.

In addition, the switching controlling unit 250 may sequentially conduct the second main switching element 222a to the second switching element 222d most distant from the second main switching element 222a among the plurality of second switching elements 222b to 222d.

For example, the switching controlling unit 250 may sequentially add the grounds of the second ground array unit 212 disposed on the other surface 200b of the printed circuit board 200. Thereby, gain and efficiency of the antenna pattern unit 100 may be increased, thereby improving radiation characteristics.

Therefore, as at least one of the first and second switching units 221 and 222 is switched on or off to be conducted or electrically blocked depending on RSSI of at least one frequency band signal provided to the antenna pattern unit 100, the ground of the antenna pattern unit 100 may be changed, whereby radiation characteristics of the antenna module according to the exemplary embodiment in the present disclosure may be improved.

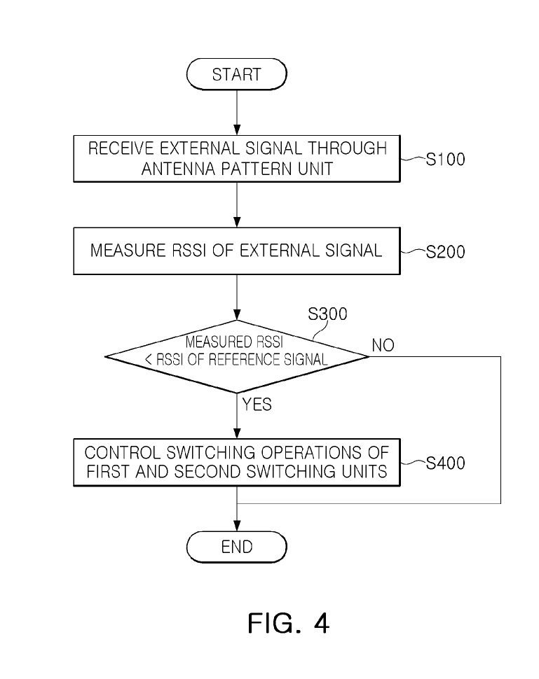

FIG. 4 is a flow chart illustrating a control method of an antenna module according to an exemplary embodiment in the present disclosure.

Referring to FIGS. 1, 2 and 4, a control method of an antenna module according to an exemplary embodiment in the present disclosure may include receiving an external signal having at least one frequency band through an antenna pattern unit 100 (S100), measuring RSSI of the external signal (S200), comparing the measured RSSI and RSSI of a reference signal (S300), and controlling switching operations of first and second switching units 221 and 222 when the measured RSSI is lower than the RSSI of the reference signal (S400).

More specifically, the RSSI measuring unit 242 may measure RSSI of a signal provided from the antenna pattern unit 100 and may provide the measurement result to the controlling unit 241.

In this case, the RSSI of the signal may be RSSI of a signal obtained by coupling the external signal received by the antenna pattern unit 100, or may also be RSSI of a signal obtained by coupling a transmit signal reflected by the antenna pattern unit 100.

The controlling unit 241 may compare the RSSI of a reference signal stored in the memory unit 243 and the RSSI of the external signal (S300) and may generate a control signal depending on the comparison result. The controlling unit 241 may provide the generated control signal to the switching controlling unit 250.

More specifically, when the RSSI of the signal provided to the antenna pattern unit 100 is lower than the RSSI of the reference signal stored in the memory unit 243, the controlling unit 241 may generate a control signal for improving RSSI to be provided to the switching controlling unit 250 (S400).

In this case, the switching controlling unit 250 may sequentially block the first switching element 222d most distant from the first main switching element 221a among the plurality of first switching elements 221b to 222d to the first main switching element 221a.

For example, the switching controlling unit 250 may sequentially remove the grounds of the first ground array unit 211 below the first radiator 110. Thereby, gain and efficiency of the antenna pattern unit 100 may be increased, thereby improving radiation characteristics.

In addition, the switching controlling unit 250 may sequentially conduct the second main switching element 222a to the second switching element 222d most distant from the second main switching element 222a among the plurality of second switching elements 222b to 222d.

For example, the switching controlling unit 250 may sequentially add the grounds of the second ground array unit 212 disposed on the other surface 200b of the printed circuit board 200. Thereby, gain and efficiency of the antenna pattern unit 100 may be increased by changing the ground of the antenna pattern unit 100, thereby improving radiation characteristics.

Therefore, the switching controlling unit 250 may sequentially remove the grounds of the first ground array unit 211 and may sequentially add the grounds of the second ground array unit 212, depending on an environmental situation of a radio wave, for example, a gain of a signal.

As set forth above, according to exemplary embodiments in the present disclosure, in the antenna module and the control method thereof, the gain and the efficiency are increased by adjusting the ground taking account of RSSI optimized according to a surrounding environment, whereby radiation characteristics of the antenna may be improved.

In addition, as radiation characteristics of the antenna are improved, wireless call quality of a consumer may be improved.

While exemplary embodiments have been shown and described above, it will be apparent to those skilled in the art that modifications and variations could be made without departing from the scope of the present invention as defined by the appended claims.

What is claimed is:

1. An antenna module comprising:
a printed circuit board including a main ground unit disposed on one surface the printed circuit board, a first ground array unit connected to the main ground unit through a first switching unit, and a second ground array unit connected to the main ground unit through a second switching unit; and
an antenna pattern unit connected to the printed circuit board and transmitting and receiving at least one frequency band signal,
wherein the printed circuit board further includes a switching controlling unit controlling switching operations of the first and second switching units according to received signal strength indicator (RSSI) of the signal received by the antenna pattern unit, and
the first ground array unit is disposed on one surface of the printed circuit board and the second ground array unit is disposed on the other surface opposing one surface of the printed circuit board.

2. The antenna module of claim 1, wherein the first ground array unit includes a plurality of first ground units connected to each other through a plurality of first switching elements,
the second ground array unit includes a plurality of second ground units connected to each other through a plurality of second switching elements,
the first switching unit includes a first main switching element opening or closing a signal path between the first ground array unit and the main ground unit to be electrically conducted or blocked, and the plurality of first switching elements, and
the second switching unit includes a second main switching element opening or closing a signal path between the second ground array unit and the main ground unit to be electrically conducted or blocked, and the plurality of second switching elements.

3. The antenna module of claim 2, wherein the printed circuit board further includes:
a RSSI measuring unit measuring RSSI of the signal provided to the antenna pattern unit;
a memory unit storing RSSI of a preset reference signal; and
a controlling unit comparing the measured RSSI and the RSSI of the preset reference signal and providing a control signal generated according to the comparison result to the switching controlling unit.

4. The antenna module of claim 3, wherein the switching controlling unit controls switching operations of the first and second main switching elements and the plurality of first and second switching elements depending on the RSSI of the signal provided to the antenna pattern unit.

5. The antenna module of claim 3, wherein when the measured RSSI is lower than the RSSI of the preset reference signal, the controlling unit electrically blocks at least one of the plurality of first switching elements and electrically conducts at least one of the plurality of second switching elements.

6. The antenna module of claim 1, wherein the antenna pattern unit includes a first radiator transmitting and receiving a first frequency band signal and a second radiator transmitting and receiving a second frequency band signal, and
the first ground array unit is disposed on one surface of the printed circuit board so as to face the first radiator.

7. A control method of an antenna module, the control method comprising:
measuring RSSI of a signal provided to an antenna pattern unit;
comparing the measured RSSI of the signal and RSSI of a reference signal; and
controlling switching operations of a first switching unit opening or closing a signal path between a main ground unit and a first ground array unit of a printed circuit board to be electrically conducted or blocked and a second switching unit opening or closing a signal path between the main ground unit and a second ground array unit of the printed circuit board to be electrically conducted or blocked, depending on the comparison result,
wherein the first ground array unit is disposed on one surface of the printed circuit board and the second ground array unit is disposed on the other surface opposing one surface of the printed circuit board.

8. The control method of claim 7, wherein the first ground array unit includes a plurality of first ground units connected to each other through a plurality of first switching elements,
the second ground array unit includes a plurality of second ground units connected to each other through a plurality of second switching elements,
the first switching unit includes a first main switching element opening or closing a signal path between the first ground array unit and the main ground unit to be electrically conducted or blocked, and the plurality of first switching elements, and
the second switching unit includes a second main switching element opening or closing a signal path between the second ground array unit and the main ground unit to be electrically conducted or blocked, and the plurality of second switching elements.

9. The control method of claim 8, further comprising blocking at least one of the plurality of first switching elements and conducting at least one of the plurality of second switching elements when the measured RSSI of the signal is lower than the RSSI of the reference signal.

10. The control method of claim 7, wherein the antenna pattern unit includes a first radiator transmitting and receiving a first frequency band signal and a second radiator transmitting and receiving a second frequency band signal, and
the first ground array unit is disposed on one surface of the printed circuit board so as to face the first radiator.
